(19) United States
(12) Patent Application Publication
(10) Pub. No.: US 2016/0257103 A1
(43) Pub. Date: Sep. 8, 2016

(54) LAYERED TEXTILE

(71) Applicant: Lifetime Brands, Inc., Garden City, NY (US)

(72) Inventors: Seung Chul Cho, Jersey City, NJ (US); John Roscoe Swartz, Ridgewood, NJ (US)

(21) Appl. No.: 15/058,346

(22) Filed: Mar. 2, 2016

Related U.S. Application Data
(60) Provisional application No. 62/128,762, filed on Mar. 5, 2015.

(51) Int. Cl. B32B 37/14; B32B 27/36; B65D 81/38; B32B 37/06

(52) U.S. Cl. CPC B32B 37/142; B32B 37/06; B32B 27/36; B65D 81/3888; B32B 2439/46; B32B 2367/00

(57) ABSTRACT

A multi-layered textile panel for use in manufacturing cooler type bags includes an outer set of layers and an inner set of layers. The outer set of layers and inner set of layers are stacked and laminated together under pressure and heat. The laminating is performed in a predetermined pattern to allow for the creation of gel cavities and soft or living hinges in the panel. A gel injection site is maintained open in a first lamination process. The gel is injected into the gel cavities via the gel injection site and one injected, the gel injection site is closed using the lamination process. The gel infused panel may now be cut and assembled into a desired bag or other shape for use.

### CROSS REFERENCE TO RELATED APPLICATIONS

This application claims priority from U.S. Provisional Patent Application Ser. No. 62/128,762 filed on Mar. 5, 2015.

### BACKGROUND

1. Technical Field

The present principles relate to textiles. More particularly, it relates to a multi-layered textile construction that has particular applications in manufacturing flexible insulated bags used to maintain goods cold/hot when contained in the same.

2. Description of Related Art

Textiles for use in insulating environments are known. To date, most textiles used for insulating are in the form of flexible cooler bags for maintaining items cold and/or hot for an extended period of time without a cooling or heating system. These known textiles tend to be bulky (due to insulation layers).

### SUMMARY

In accordance with an aspect of the present principles, the multi-layered textile construction includes an outer set of layers and an inner set of layers. The outer set of layers and inner set of layers are laminated together under heat and pressure to form water tight cavities. A gel is then injected into the water tight cavities.

In accordance with another aspect, the water tight cavities further comprise soft hinges formed by the lack of lamination under heat and pressure. The soft hinges enable the folding of the multi-layered textile along the same after the gel has been injected into the water tight cavities.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIGS. 1 is a schematic view of the multi-layered textile construction according to an implementation of the present principles;

FIG. 2 is a line drawing showing a cooler bag using the multi-layered textile construction shown in FIG. 1;

FIG. 3 is a line drawing showing the cooler bag using the multi-layered textile construction shown in FIG. 1

FIG. 4 is a schematic view of one panel of the cooler bag during a manufacturing stage of the same;

FIG. 5 is another schematic view of the cooler bag panel of FIG. 4 after another manufacturing step, according to an implementation of the present principles; and

FIG. 6 is a flow diagram of the method for making the cooler bag, according to an implementation of the present principles.

### DETAILED DESCRIPTION

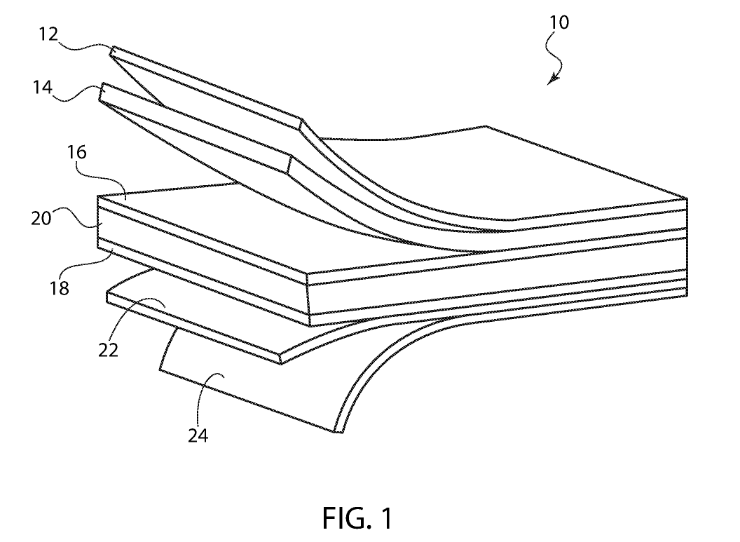

Referring to FIG. 1 there is shown the structure of the multi-layer textile construction 10 according to an implementation of the present principles. According to a preferred implementation, there is an outer set of layers and an inner set of layers. The outer set is made of up layers 12, 14 and 16, and the inner set of layers is made up of layers 18, 22 and 24.

The outer most layer 12 is preferably a polyester layer, the next layer is an insulating layer 14, for example a PE foam. A polyethylene film 16 is the next layer. The gel layer 20 is shown here, but is actually injected into the textile once the lamination process has been completed. This will be described in further detail below. On the inner side of the gel layer 20 is another polyethylene film layer 18, a polyethylene terephthalate file 22 and an inner most aluminum fabric 24.

In accordance with a preferred implementation, the layers (without the gel) are laminated together under heat and pressure. Those of skill in the art of the lamination process will appreciate that glue or other type of adhesives is used between the layers before the application of heat/pressure. By applying the heat/pressure in a predetermined pattern (discussed below) a complete gel panel with insulation can be manufactured in one process. This creates a significantly less bulky panel which makes for increased flexibility to design different shapes and sizes. In addition, the heat/pressure lamination process of these layers eliminates the need for stitching and thread which would otherwise be exposed on the inner most foil layer and has been proven to make the cleaning of the inside foil layer more difficult. Thus, by having no stitching needed to form the gel panels, the cleaning of the inside of the bag is simple and without any obstacles that can catch and retainer dirt/food/drink, etc.

As will be appreciated, this above described multi-layered textile design, in addition to the lamination process for making the respective panels allows for the thinnest possible panel while maintaining the strength, integrity and insulating (cooling or heating) characteristics of the same.

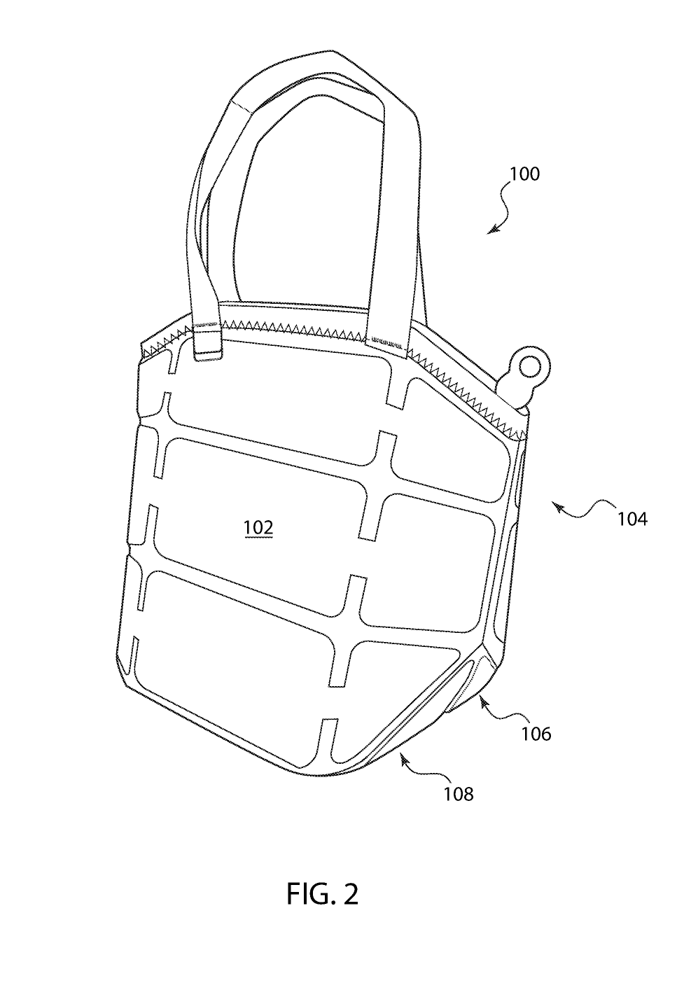

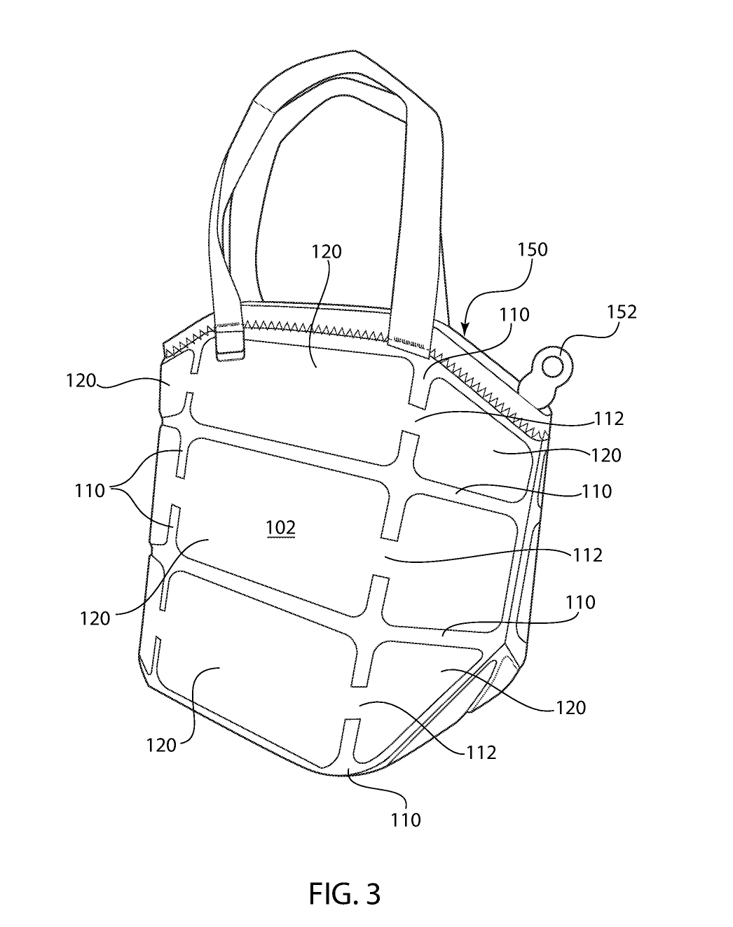

FIGS. 2-3 show an example of an insulated bag 100 using the multi-layered textile construction of the present principles. In this example, the bag 100 is made up of 4 panels, 102, 104, 106 and 108 (FIG. 2) that are fabricated with the lamination process. Using panel 102 as an example, there can be seen areas 110 that are where the lamination/heat has been applied to form the multi-layered textile and which further operate to form gel cavities 120 across the entire surface of the panel. In this manner, the entire textile can be manufactured, and this will then create water tight gel cavities 120. The gel is then inserted (i.e., injected) into the cavities 120 until filled to a predetermined level and finally sealed at the point of injection. This filling is preferably formed along one of the edges of the panel such that once filled, the edge is laminated (heat and pressure applied) to the same to permanently seal the same.

The openings 112 in the gel cavities 120 (see FIG. 3) serve two functions: 1) to allow the injection of the gel to span across the entire panel (thus requiring only one point of injection/insertion); and 2) to operate as a soft or living hinge, that allows the panel to be easily folded at those points. Thus, creating a significantly more flexible insulated gel panel than currently known.

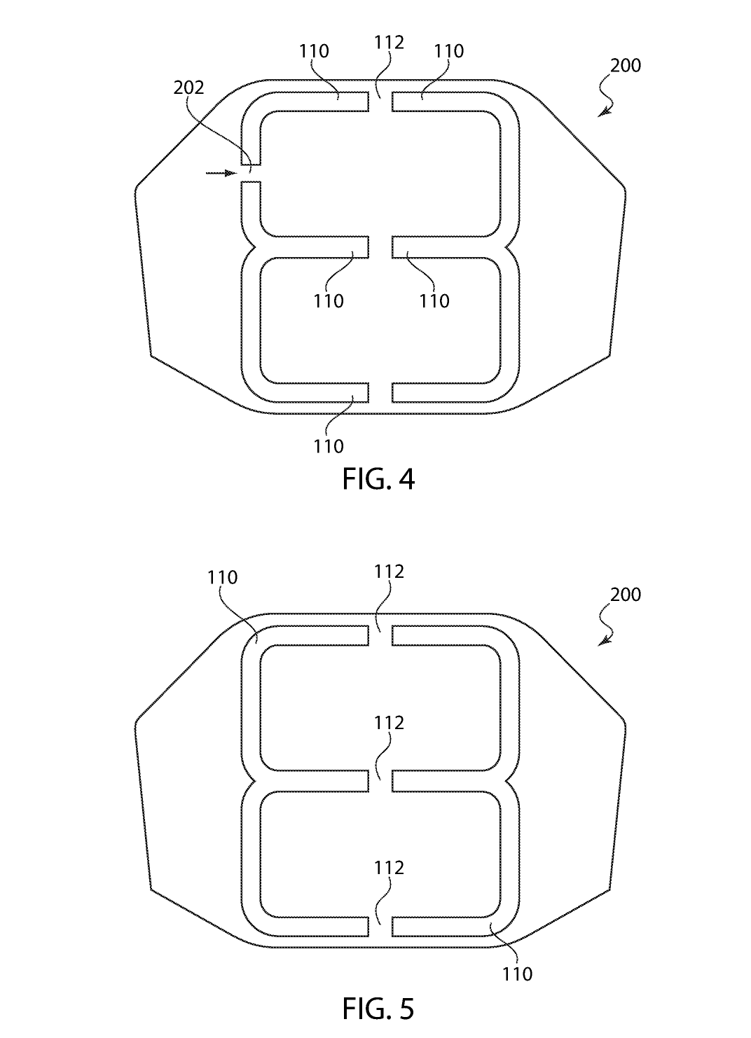

FIGS. 4 show a schematic representation of a panel 200 before gel insertion. As shown, the panel 200 includes the lamination/heat applied areas 110, with the openings or living hinges 112 formed by the same. As also shown, an injection site 202 is provided during the initial lamination process. The injection site 202 allows for a manual or automatic system to inject the gel 20 (See FIG. 1) into the panel. Once the desired amount of gel has been injected into the panel, the injection site opening 202 is closed by the application of the lamination/heat process. FIG. 5 shows the panel 200 after the injection site 202 has been closed. In the example shown in FIGS. 4 and 5, it is assumed that the edges of the panel are also laminated (like that shown in FIGS. 2 and 3), so that the injected gel remains completely inside the panel.

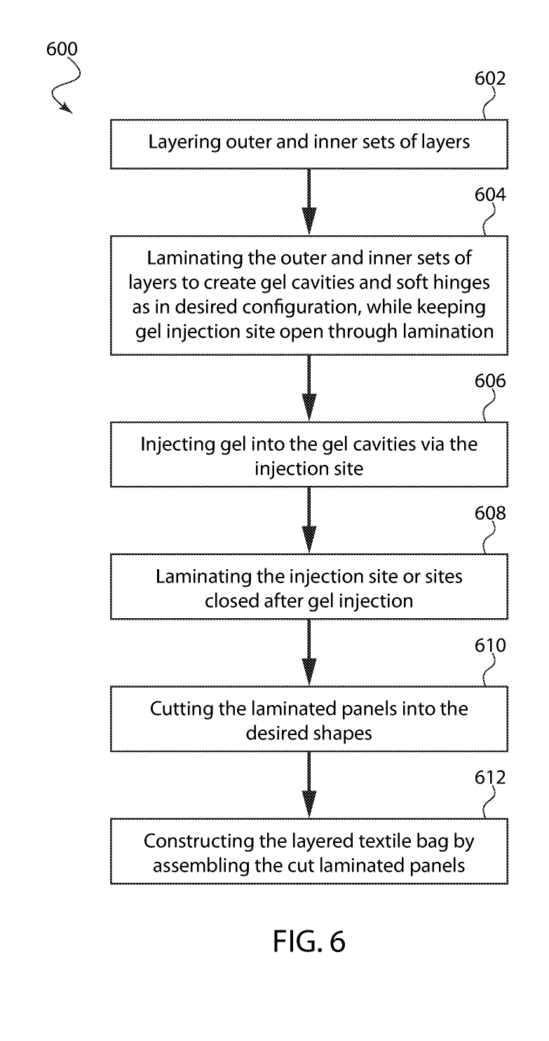

As will be appreciated from FIGS.1, 4 and 5, and as shown in FIG. 6, the method 600 for manufacturing the layered textile of the present principles includes:

1) layering (602) the outer set of layers 12, 14 and 16, and the inner set of layers 18, 22 and 24;

2) laminating (604) outer set and inner sets of layers to create the gel cavities and living or soft hinges in the desired locations, while leaving one or more gel injection sites in the lamination lines or locations;

3) injecting (606) the gel into the laminated panel using the one or more injection sites;

4) laminating (608) closed the injection sites;

5) cutting (610) the laminated panels with gel inserted along predetermined lamination points to form the insulated panel in the desired shape; and

6) constructing (612) the layered textile bag bas assembling the cut gel filled laminated panels.

Those of skill in the art will appreciate that “constructing” the bag is intended to mean assembling the panels so they form the desired bag, and adding a zipper or other closure means for the same. In addition, with this manufacturing, a minimum of two (2) layered panels can be used to construct a fully functional insulated bag in accordance with the present principles.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

What is claimed is:

1. A multi-layered textile comprising:
at least one panel comprising:
an outer set of layers;
an inner set of layers, said outer set of layers and inner set of layers being laminated together under heat and pressure to form water tight gel receiving cavities between the two sets of layers, said cavities being defined by lamination points and spaces in the lamination points that function as soft or living hinges; and
a gel injected into the water tight cavities;
wherein said soft hinges enable the folding of the multi-layered textile along the same after the gel has been injected into the water tight gel receiving cavities.

2. The multi-layered textile according to claim 1, further comprising two panels, each of said two panels being assembled to form an insulated bag with an open top.

3. The multi-layered textile according to claim 1, further comprising two panels, each of said two panels being assembled to form an insulated bag with an open top.

4. The multi-layered textile according to claim 1, wherein said outer set of layers comprises a polyester layer, a PE foam layer and a polyethylene film layer.

5. The multi-layered textile according to claim 1, wherein said inner set of layers comprises an aluminum fabric layer, a polyethylene terephthalate film layer and a polyethylene film layer.

6. The multi-layered textile according to claim 4, wherein said inner set of layers comprises an aluminum fabric layer, a polyethylene terephthalate film layer and a polyethylene film layer, said gel being injected between the polyethelene film layer of each of the outer set and inner set of layers.

7. A method of manufacturing layered textile panels used to create bags; the method comprising:
layering an outer set and an inner sets of layers;
laminating the outer set and inner set of layers together by applying heat in a pre-determined pattern, said laminating in an predetermined pattern, said predetermined pattern creating gel cavities between the inner set and outer set of layers, and also forming soft hinges in areas where the predetermined pattern does not include laminating;
injecting a gel into the gel cavities via an open gel injection site in the predetermined patter of lamination;
laminating closed the open gel injection site;
cutting the laminated panels to a desired shape; and
constructing a bag using one or more cut laminated layered textile panels.

8. The method according to claim 7, wherein said layering further comprises:
assembling an outer set of layers using an outermost polyester layer, a PE foam layer and an innermost polyethylene film layer; and
assembling the inner set of layers using an innermost aluminum fabric layer, a polyethylene terephthalate film layer and outermost a polyethylene film layer;
wherein said gel cavities are formed between the innermost polyethylene film layer of the outer set of layers and the outermost polyethylene film later of the inner set of layers.

9. The method according to claim 7, wherein said laminating comprises applying heat and pressure to the inner and outer sets of layers together.

10. The method according to claim 7, wherein the predetermined pattern for said laminating includes laminating borders which assist in creating the gel cavities and enable said cutting along said laminated borders.
